(19) United States
(12) Patent Application Publication
(10) Pub. No.: US 2025/0320328 A1
(43) Pub. Date: Oct. 16, 2025

(54) EPOXY RESIN CURABLE COMPOSITION AND ADHESIVE CONTAINING THE SAME

(71) Applicant: Toray Fine Chemicals Co., Ltd., Tokyo (JP)

(72) Inventors: Hiromitsu Abe, Ichihara-shi, Chiba (JP); Motoharu Seo, Ichihara-shi, Chiba (JP)

(73) Assignee: Toray Fine Chemicals Co., Ltd., Tokyo (JP)

(21) Appl. No.: 18/555,811

(22) PCT Filed: Apr. 22, 2022
(86) PCT No.: PCT/JP2022/018542

§ 371 Date: Aug. 8, 2024

(30) Foreign Application Priority Data
Apr. 28, 2021 (JP) 2021-076165
Mar. 11, 2022 (JP) 2022-037761

(51) Int. Cl. C08G 59/56; C08G 59/66; C08K 5/37

(52) U.S. Cl. CPC C08G 59/56; C08G 59/66; C08K 5/37

(57) ABSTRACT

An epoxy resin curable composition contains an epoxy resin containing two or more epoxy groups in one molecule, a thiol compound A containing two or more thiol groups in one molecule, an amine compound containing a primary amino group and/or a secondary amino group, and a thiol compound B represented by any one of specific Formulas, in which the thiol compound A and the thiol compound B are different from each other, and a molar ratio M_{A}/Me is 0.29 to 0.80 and a molar ratio M_{B}/Me is 0.02 to 0.4, in which Me is the number of moles of the epoxy groups contained in the epoxy resin curable composition, M_{A} is the number of moles of the thiol groups in the thiol compound A, and M_{B} is the number of moles of the thiol groups in the thiol compound B.

### TECHNICAL FIELD

This disclosure relates to an epoxy resin curable composition that cures quickly, has high hardness after curing and strong adhesive strength, and provides a cured product having an excellent color tone.

### BACKGROUND

An epoxy resin has excellent adhesiveness, chemical resistance, and physical properties, and is widely used as an adhesive and the like. For applications requiring rapid curing and high adhesive strength, a method of adding a thiol compound as a curing agent and amines as a curing accelerator is known.

Many terminal thiol group-containing compounds having no polysulfide skeleton in the main chain have been reported as compounds capable of rapidly reacting a thiol group with an epoxy group (see, for example, JP 8-269203 A). Among them, as a curing agent for an epoxy resin having both economic efficiency and safety, a compound containing a polyether skeleton in the main chain and containing three or more thiol groups in one molecule is widely commercially available. Examples of the compound containing a polyether skeleton in the main chain and three or more thiol groups in one molecule include “Polythiol QE-340M” manufactured by Toray Fine Chemicals Co., Ltd., and “Capcure3-800” and “GPM-800” manufactured by Gabriel Performance Products, LLC.

Examples of an amine widely used as a curing accelerator for a thiol group and an epoxy group include tertiary amines such as 2,4,6-tris(dimethylaminomethyl)phenol (ANCAMINE K-54 manufactured by Evonik Industries AG), N,N-dimethylpropylamine, and bis(2-dimethylaminoethyl) ether.

However, a known epoxy resin curable composition turns yellow and is colored when cured, and thus has a problem in applications required to be close to colorless and to have an excellent color tone such as an adhesive for glass and an adhesive for a decorative item.

A known colorless epoxy resin curable composition cures slowly, is not suitable for applications requiring rapid curing, and does not necessarily have sufficient hardness and adhesive strength. As described above, it has been difficult for an epoxy resin curable composition containing an epoxy resin, a thiol compound, and an amine compound to have quick curing, hardness, adhesive strength, and a color tone.

It could therefore be helpful to provide an epoxy resin curable composition that cures quickly, has high hardness after curing, and has an excellent color tone.

### SUMMARY

An epoxy resin curable composition contains an epoxy resin containing two or more epoxy groups in one molecule, a thiol compound A containing two or more thiol groups in one molecule, an amine compound containing a primary amino group and/or a secondary amino group, and a thiol compound B represented by any one of Formulas (1) to (3), in which the thiol compound A and the thiol compound B are different from each other, and a molar ratio M_{A}/Me is 0.29 to 0.80 and a molar ratio M_{B}/Me is 0.02 to 0.4, in which Me is the number of moles of the epoxy groups contained in the epoxy resin curable composition, M_{A} is the number of moles of the thiol groups in the thiol compound A, and M_{B} is the number of moles of the thiol groups in the thiol compound B,

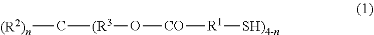

wherein, in Formula (1), R¹'s each independently represent an alkylene group having 1 to 10 carbon atoms, R² represents a hydrogen atom, an alkyl group having 1 to 10 carbon atoms, or a hydroxyalkyl group having 1 to 3 carbon atoms, R³'s each independently represent an alkylene group having 1 to 3 carbon atoms, n represents an integer of 0 to 2, and —SH is bonded to any carbon atom of R¹,

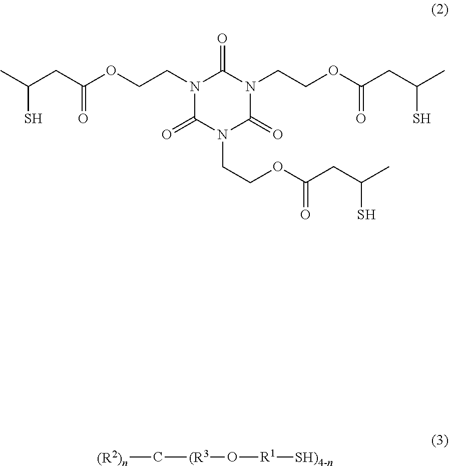

wherein, in Formula (3), R¹'s each independently represent an alkylene group having 1 to 10 carbon atoms, R² represents a hydrogen atom, an alkyl group having 1 to 10 carbon atoms, or a hydroxyalkyl group having 1 to 3 carbon atoms, R³'s each independently represent an alkylene group having 1 to 3 carbon atoms, n represents an integer of 0 to 2, and —SH is bonded to any carbon atom of R¹.

Our epoxy resin curable composition thus cures quickly, has high hardness after curing, and has strong adhesive strength and an excellent color tone.

When the epoxy resin curable composition is used as an adhesive, the adhesive strength is strong to various adherends such as a metal and glass. The epoxy resin curable composition can be used as an adhesive, a sealing material, a potting material, a coating agent, a modifier for a resin or the like.

In particular, since the epoxy resin curable composition has an excellent color tone, it is optimal for an adhesive for glass, an adhesive for a decorative item, an adhesive for a timepiece part, an adhesive for electrical and electronic applications, a potting material for electrical and electronic applications, and an adhesive for DIY.

### DETAILED DESCRIPTION

Our epoxy resin curable composition contains an epoxy resin containing two or more epoxy groups in one molecule, a thiol compound A containing two or more thiol groups in one molecule, an amine compound containing a primary amino group and/or a secondary amino group, and a thiol compound B that is represented by a specific structural formula and is different from the thiol compound A.

Examples of the epoxy resin containing two or more epoxy groups in one molecule include an epoxy resin obtained by adding epichlorohydrin to a polyhydric phenol such as bisphenol A, bisphenol F, resorcinol, hydroquinone, pyrocatechol, 4,4-dihydroxybiphenyl, or 1,5-hydroxynaphthalene, an epoxy resin obtained by adding epichlorohydrin to a polyhydric alcohol such as ethylene glycol, propylene glycol, or glycerin, an epoxy resin obtained by adding epichlorohydrin to an aromatic dicarboxylic acid such as oxybenzoic acid or phthalic acid, and a polysulfide polymer containing an epoxy group at a terminal (trade names: “FLEP-50” and “FLEP-60”, both manufactured by Toray Fine Chemicals Co., Ltd.). The epoxy resin containing two or more epoxy groups in one molecule is preferably a liquid at normal temperature from the viewpoint of workability and suppression of mixing failure. Examples of the epoxy resin containing two or more epoxy groups in one molecule include jER-828 (trade name, manufactured by Mitsubishi Chemical Group Corporation), DER-331 (trade name, manufactured by The Dow Chemical Company), jER-825 (trade name, manufactured by Mitsubishi Chemical Group Corporation), jER-827 (trade name, manufactured by Mitsubishi Chemical Group Corporation), jER-806 (trade name, manufactured by Mitsubishi Chemical Group Corporation), and jER-807 (trade name, manufactured by Mitsubishi Chemical Group Corporation).

An epoxy equivalent of the epoxy resin containing two or more epoxy groups in one molecule is preferably 50 to 1,000 g/eq. The epoxy equivalent of the epoxy resin containing two or more epoxy groups in one molecule is more preferably 100 to 300 g/eq.

When the epoxy resin curable composition contains at least two types of thiol compounds including the thiol compound A and the thiol compound B, the epoxy resin curable composition cures quickly, has high hardness after curing, and has high adhesive strength and an excellent color tone.

The thiol compound B is a compound different from the thiol compound A, and is a thiol compound represented by any one of Formulas (1) to (3).

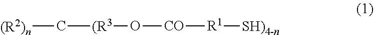

Wherein, in Formula (1), R¹'s each independently represent an alkylene group having 1 to 10 carbon atoms, R² represents a hydrogen atom, an alkyl group having 1 to 10 carbon atoms, or a hydroxyalkyl group having 1 to 3 carbon atoms, R³'s each independently represent an alkylene group having 1 to 3 carbon atoms, n represents an integer of 0 to 2, and —SH is bonded to any carbon atom of R¹.

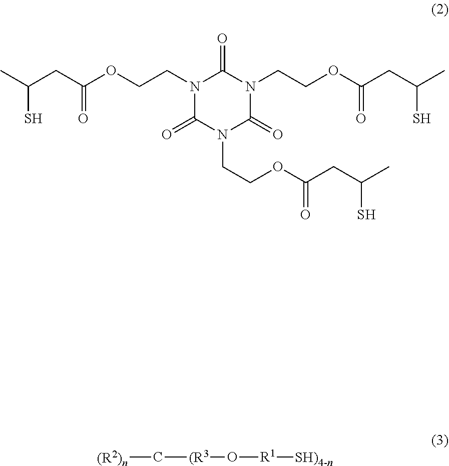

Wherein, in Formula (3), R¹'s each independently represent an alkylene group having 1 to 10 carbon atoms, R² represents a hydrogen atom, an alkyl group having 1 to 10 carbon atoms, or a hydroxyalkyl group having 1 to 3 carbon atoms, R³'s each independently represent an alkylene group having 1 to 3 carbon atoms, n represents an integer of 0 to 2, and —SH is bonded to any carbon atom of R¹.

In Formula (1), a plurality of R¹'s are each independently an alkylene group having 1 to 10 carbon atoms, preferably an alkylene group having 2 to 7 carbon atoms, more preferably an alkylene group having 2 to 4 carbon atoms. The plurality of R¹'s may be the same as or different from each other. Examples of the alkylene group R¹ include a methylene group, an ethylene group, a propylene group, a 1-methylethylene group, a butylene group, an ethylethylene group, and a dimethylethylene group.

In Formula (1), a plurality of R³'s are each independently an alkylene group having 1 to 3 carbon atoms and preferably an alkylene group having 1 to 2 carbon atoms. The plurality of R³'s may be the same as or different from each other. Examples of the alkylene group R³ include a methylene group, an ethylene group, a propylene group, and a methylethylene group.

In Formula (1), a plurality of R²'s are each independently a hydrogen atom, an alkyl group having 1 to 10 carbon atoms, or a hydroxyalkyl group having 1 to 3 carbon atoms, and preferably hydrogen, an alkyl group having 1 to 4 carbon atoms, or a hydroxyalkyl group having 1 to 2 carbon atoms. The plurality of R³'s may be the same as or different from each other. Examples of the alkyl group R³ include a methyl group, an ethyl group, an n-propyl group, an isopropyl group, an n-butyl group, an isobutyl group, a sec-butyl group, and a tert-butyl group. Examples of the hydroxyalkyl group include a methylol group, a hydroxyethyl group, and a hydroxypropyl group.

In Formula (1), n represents an integer of 0 to 2, and —SH is bonded to any carbon atom constituting the alkylene group R¹.

Examples of the thiol compound B represented by Formula (1) include 1,4-bis(3-mercaptopropionyloxy) butane, 1,4-bis(3-mercaptobutyryloxy)butane, trimethylolpropane tris(3-mercaptopropionate), trimethylolpropane tris(3-mercaptobutyrate), trimethylolpropane tris(3-mercaptoisobutyrate), trimethylolpropane tris(2-mercaptoisobutyrate), trimethylolpropane tristhioglycolate, pentaerythritol tetrakis(3-mercaptopropionate), pentaerythritol tetrakis(3-mercaptobutyrate), pentaerythritol tetrakis(3-mercaptoisobutyrate), pentaerythritol tetrakis(2-mercaptoisobutyrate), and pentaerythritol tetrakisthioglycolate.

In Formula (3), a plurality of R¹'s are each independently an alkylene group having 1 to 10 carbon atoms, preferably an alkylene group having 2 to 7 carbon atoms, more preferably an alkylene group having 2 to 4 carbon atoms. The plurality of R¹'s may be the same as or different from each other. Examples of the alkylene group R¹ include a methylene group, an ethylene group, a propylene group, a 1-methylethylene group, a butylene group, an ethylethylene group, and a dimethylethylene group.

In Formula (3), a plurality of R³'s are each independently an alkylene group having 1 to 3 carbon atoms and preferably an alkylene group having 1 to 2 carbon atoms. The plurality of R³'s may be the same as or different from each other. Examples of the alkylene group R³ include a methylene group, an ethylene group, a propylene group, and a methylethylene group.

In Formula (3), a plurality of R²'s are each independently a hydrogen atom, an alkyl group having 1 to 10 carbon atoms, or a hydroxyalkyl group having 1 to 3 carbon atoms, and preferably hydrogen, an alkyl group having 1 to 4 carbon atoms, or a hydroxyalkyl group having 1 to 2 carbon atoms. The plurality of R³'s may be the same as or different from each other. Examples of the alkyl group R³ include a methyl group, an ethyl group, an n-propyl group, an isopropyl group, an n-butyl group, an isobutyl group, a sec-butyl group, and a tert-butyl group. Examples of the hydroxyalkyl group include a methylol group, a hydroxyethyl group, and a hydroxypropyl group.

In Formula (3), n represents an integer of 0 to 2, and —SH is bonded to any carbon atom constituting the alkylene group R¹.

Examples of the thiol compound B represented by Formula (3) include trimethylolpropane monopropanethiol, trimethylolpropane bis(propanethiol), trimethylolpropane tris(propanethiol), pentaerythritol monopropanethiol, pentaerythritol bis(propanethiol), pentaerythritol tris(propanethiol), and pentaerythritol tetrakis(propanethiol).

The thiol compound A is a compound different from the thiol compound B described above, and is a thiol compound containing two or more thiol groups in one molecule. The thiol compound A preferably contains a polyether moiety in the main chain, and may contain a thiol group on a carbon adjacent to a carbon having a hydroxy group. Furthermore, the thiol compound A preferably does not contain a carbonyl group. When the thiol compound A does not contain a carbonyl group, hydrolysis of a cured product is suppressed and water resistance is improved, which is preferable.

A structure having a polyether moiety in the main chain is preferably represented by Formula (4), and a terminal thiol group is preferably represented by Formula (5).

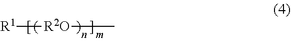

R¹ is a residue obtained by removing m hydrogen atoms from a polyvalent amine or polyhydric alcohol having 10 or fewer carbon atoms, R² is an alkylene group having 2 to 4 carbon atoms, n is an integer of 1 to 200, and m is an integer of 2 to 8.

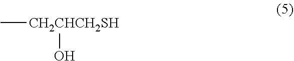

In Formula (4), R¹ is a residue obtained by removing m hydrogen atoms from a polyvalent amine or polyhydric alcohol having 10 or fewer carbon atoms. Examples of the polyvalent amine or polyhydric alcohol having 10 or fewer carbon atoms include glycerin, trimethylolpropane, trimethylolethane, hexanetriol, diglycerin, pentaerythritol, triethanolamine, ethylenediamine, and sucrose. These polyvalent amines and polyhydric alcohols may be used alone or in combination. Among the polyols described above, glycerin, trimethylolpropane, and trimethylolethane are particularly preferable.

In Formula (4), R² is an alkylene group having 2 to 4 carbon atoms. Examples of the alkylene group having 2 to 4 carbon atoms include ethylene, n-propylene, isopropylene, n-butylene, and isobutylene.

In Formula (4), n is an integer of 1 to 200 and preferably an integer of 1 to 100. In addition, m is an integer of 2 to 8 and preferably an integer of 2 to 5.

Examples of the thiol compound A that has a structure represented by Formulas (4) and (5) and does not contain a carbonyl group include “Polythiol QE-340M” manufactured by Toray Fine Chemicals Co., Ltd., and “Capcure3-800” and “GPM-800” manufactured by Gabriel Performance Products, LLC.

The thiol compound A containing two or more thiol groups in one molecule preferably contains at least one thiol group represented by Formula (5), and more preferably contains two or more thiol groups. In the thiol compound A, all thiol groups may be contained as a structure represented by Formula (5).

In the thiol compound A containing two or more thiol groups in one molecule, a content of the thiol groups is preferably 1 to 50 mass %, and the content of the thiol groups is more preferably 5 to 20 mass %.

The fact that the thiol compound A does not contain a carbonyl group means that the thiol compound A does not contain a carbonyl group, a carboxy group, a thiocarboxy group, an amide group, an ester bond, a thioester bond and the like.

In the epoxy resin and the thiol compound described above, a molar ratio M_{A}/Me of the number of moles M_{A} of the thiol groups derived from the thiol compound A to the number of moles Me of the epoxy groups derived from the epoxy resin present in the epoxy resin curable composition is 0.29 to 0.8, and a molar ratio M_{B}/Me of the number of moles M_{B} of the thiol groups derived from the thiol compound B to the number of moles Me of the epoxy groups derived from the epoxy resin present in the epoxy resin curable composition is 0.02 to 0.4.

When the molar ratio M_{A}/Me is less than 0.29, a curing rate is reduced. In addition, when the molar ratio M_{A}/Me exceeds 0.8, a Shore D hardness of the cured product of the epoxy resin curable composition cannot be increased. On the other hand, when the molar ratio M_{B}/Me is less than 0.02, the Shore D hardness of the cured product cannot be increased. In addition, when the molar ratio M_{B}/Me exceeds 0.4, the Shore D hardness of the cured product of the epoxy resin curable composition is rather decreased. A blending amount of each component can be determined so that the molar ratio M_{A}/Me is preferably 0.29 to 0.7, more preferably 0.29 to 0.65, and still more preferably 0.29 to 0.57. The blending amount of each component can be determined so that the molar ratio M_{B}/Me is preferably 0.02 to 0.3, more preferably 0.03 to 0.2, and still more preferably 0.04 to 0.14.

In the epoxy resin curable composition, a molar ratio M_{B}/M_{A} of the number of moles M_{B} of the thiol groups derived from the thiol compound B to the number of moles M_{A} of the thiol groups derived from the thiol compound A present in the composition is preferably 0.02 to 0.5, more preferably 0.04 to 0.4, and still more preferably 0.13 to 0.34. When the molar ratio M_{B}/M_{A} is 0.02 or more, the Shore D hardness of the cured product is increased, which is preferable. In addition, the molar ratio M_{B}/M_{A} is 0.5 or less, the curing rate is increased, which is preferable.

The blending amount of the thiol compound A can be appropriately designed to satisfy the molar ratio M_{A}/Me described above and preferably to satisfy the molar ratio M_{B}/M_{A} according to the physical properties of the epoxy resin curable composition. For example, it is preferable to blend 50 to 150 parts by mass of the thiol compound A with respect to 100 parts by mass of an epoxy resin containing two or more epoxy groups in one molecule. When the amount of the thiol compound A is 50 to 150 parts by mass with respect to 100 parts by mass of the epoxy resin, the epoxy resin curable composition cures quickly, has high hardness of a cured product, and has sufficient adhesive strength. The blending amount of the thiol compound A with respect to 100 parts by mass of the epoxy resin is more preferably 60 to 120 parts by mass and more preferably 70 to 100 parts by mass.

The blending amount of the thiol compound B can be appropriately designed to satisfy the molar ratio M_{B}/Me described above and preferably to satisfy the molar ratio M_{B}/M_{A} according to the physical properties of the epoxy resin curable composition. For example, it is preferable to blend 1 to 40 parts by mass of the thiol compound B with respect to 100 parts by mass of an epoxy resin containing two or more epoxy groups in one molecule. When the amount of the thiol compound B is 1 to 40 parts by mass with respect to 100 parts by mass of the epoxy resin, a cured product having a high Shore D hardness and an excellent curing rate can be obtained. The blending amount of the thiol compound B with respect to 100 parts by mass of the epoxy resin is more preferably 1 to 20 parts by mass and more preferably 2 to 12 parts by mass.

The epoxy resin curable composition contains an amine compound containing a primary amino group and/or a secondary amino group. The amine compound may contain only a primary amino group derived from a primary amine, may contain only a secondary amino group derived from a secondary amine, or may contain a primary amino group derived from a primary amine and a secondary amino group derived from a secondary amine.

The amine compound is preferably an aliphatic amine. Examples of the aliphatic amine include ethylenediamine, 1,2-diaminopropane, 1,3-diaminopropane, 1,5-diaminopentane, hexamethylenediamine, tetramethylenediamine, trimethylhexamethylenediamine, 2-methyl-1,5-diaminopentane, polyetherdiamine, 1,3-diaminopropane, diethylenetriamine, triethylenetetramine, tetraethylenepentamine, pentaethylenehexamine, dipropylenetriamine, and bis(hexamethylene)triamine. The amine compound is preferably not an amine in which the amino group of the aliphatic amine is composed only of a secondary amino group. That is, the aliphatic amine may contain at least one primary amino group.

The amine compound is more preferably an amine containing two or more primary amino groups and/or secondary amino groups in one molecule and containing no tertiary amino group. Examples of the amine compound include ethylenediamine, 1,2-diaminopropane, 1,3-diaminopropane, 1,5-diaminopentane, hexamethylenediamine, tetramethylenediamine, trimethylhexamethylenediamine, 2-methyl-1,5-diaminopentane, polyetherdiamine, diethylenetriamine, triethylenetetramine, tetraethylenepentamine, pentaethylenehexamine, dipropylenetriamine, bis(hexamethylene)triamine, diethylenetriamine, triethylenetetramine, tetraethylenepentamine, pentaethylenehexamine, dipropylenetriamine, and bis(hexamethylene)triamine. Examples of the amine containing two or more amino groups in one molecule and containing no tertiary amino group in the molecule more preferably include ethylenediamine, diethylenetriamine, triethylenetetramine, 1,3-diaminopropane, and tetraethylenepentamine.

The amine compound more preferably contains three or more primary amino groups and/or secondary amino groups in one molecule. The amine having three or more amino groups in one molecule is preferably diethylenetriamine, triethylenetetramine, tetraethylenepentamine, pentaethylenehexamine, dipropylenetriamine, or bis(hexamethylene)triamine, and more preferably triethylenetetramine.

The amine compound is particularly preferably a modified product obtained by using an amine containing three or more primary amino groups and/or secondary amino groups in one molecule as a raw material. As the modified product obtained by using an amine containing three or more amino groups in one molecule as a raw material, a modified product of diethylenetriamine, a modified product of triethylenetetramine, a modified product of tetraethylenepentamine and the like are particularly preferable, and among them, a modified product obtained by reacting an amino group of triethylenetetramine with a mono- or polyepoxy compound is more preferable. Examples of the modified product obtained by using an amine containing three or more amino groups in one molecule as a raw material include “BB-AMINE 3138” manufactured by BB RESINS SRL.

The modified product obtained by using an amine containing three or more amino groups in one molecule as a raw material preferably has an amine value of 500 to 2,500 KOHmg/g, and more preferably has an amine value of 800 to 1,700 KOHmg/g.

The blending amount of the amine compound can be appropriately designed depending on the physical properties of the cured product. For example, it is preferable to blend 1 to 30 parts by mass of the amine compound with respect to 100 parts by mass of an epoxy resin containing two or more epoxy groups in one molecule. When the amount of the amine compound is 1 to 30 parts by mass with respect to 100 parts by mass of the epoxy resin, it is possible to obtain a cured product that cures quickly, has sufficient adhesive strength, and has excellent color toning property. The blending amount of the amine compound with respect to 100 parts by mass of the epoxy resin is more preferably 2 to 30 parts by mass and more preferably 5 to 30 parts by mass.

Our epoxy resin curable composition cures at room temperature. The epoxy resin curable composition has an excellent color tone close to colorless and/or white after curing.

The excellent color tone means that a cured product having a thickness of 8 mm has a chromaticity a* of −10 to +10 and a chromaticity b* of −15 to +15 in an L*a*b* color system. When the chromaticity a* is out of the range of −10 to +10, the color tone becomes dark. A cured product having a thickness of 8 mm of the epoxy resin curable composition preferably has a chromaticity a of −8 to +8 and a chromaticity b* of −13 to +15 in the L*a*b* color system. A cured product having a thickness of 8 mm of the epoxy resin curable composition after curing for 24 hours under conditions of 23° C. and 50% RH more preferably has a chromaticity a of −8 to +5 and a chromaticity b* of −10 to +15 in the L*a*b* color system. The chromaticity a* of the cured product is more preferably −7 to +3 and still more preferably −5 to +1. The chromaticity b* of the cured product is more preferably −7 to +13, still more preferably −5 to +12, and particularly preferably-1 to +11.

In the color tone of the cured product having a thickness of 8 mm of the epoxy resin curable composition, a lightness L* is preferably 50 or more, more preferably 55 or more, and still more preferably 60 or more, in a color space of the L*a*b* color system.

The color space of the L*a*b* color system is one of color display methods established by the International Commission on Illumination (CIE) in 1976, and represented by the lightness (L* value), the degree of magenta and green (a value), and the degree of yellow and blue (b* value) by physically measuring the stimulus amount of color light that causes color sensation. When the L* value is 0, black is represented, when the L* value is 100, white is represented, when the a* value is a negative value, a color close to green is represented, when the a* value is a positive value, a color close to red is represented, when the b* value is a negative value, a color close to blue is represented, and when the b* value is a positive value, a color close to yellow is represented.

The measurement method of the L*a*b* color space is obtained by performing measurement using a color difference meter (for example, trade name “CR-300” manufactured by Minolta Co., Ltd., color difference meter) which is a measurement apparatus specified in Japanese Industrial Standards JIS Z 8781-4:2013.

The epoxy resin curable composition preferably has a curing time of 1 to 20 minutes. As for the curing time of the epoxy resin curable composition, when 10 g of the epoxy resin curable composition is used and cured at 23° C. and 50% RH, the curing time is more preferably 1 to 15 minutes and still more preferably 1 to 10 minutes. When the curing time is 1 to 15 minutes, it is suitable and preferable for applications requiring rapid curing.

The measurement of the curing time was performed with reference to the method of determining a pot life of a multi-component adhesive described in JIS K 6870 (Method 1). The curing time was defined as a point at which a thiol compound and an amine compound were mixed at a predetermined ratio with 10 g of an epoxy resin under conditions of 23° C. and 50% RH, a toothpick was put in the epoxy resin curable composition, and the toothpick stopped moving.

When the epoxy resin curable composition is applied to a thickness of 6.0 mm or more and is cured at 23° C. and 50% RH, a Shore D hardness in accordance with JIS K7215 after 3 hours from the start of curing is preferably 70 or more, and the Shore D hardness in accordance with JIS K7215 after 24 hours from the start of curing is preferably 75 or more. When the Shore D hardness after 3 hours from the start of curing is 70 or more, a cured product having high adhesive strength is obtained, which is preferable. The Shore D hardness after 3 hours from the start of curing is more preferably 71 to 85 and still more preferably 73 to 84. In addition, when the Shore D hardness after 24 hours from the start of curing is 75 or more, a cured product having high adhesive strength is obtained, which is preferable. The Shore D hardness after 24 hours from the start of curing is more preferably 76 to 85 and still more preferably 78 to 84.

The epoxy resin curable composition may further contain a filler, a plasticizer, a flexibility imparting agent, a coupling agent, an antioxidant, a thixotropy imparting agent, a dispersant and the like as long as the desired effect is not impaired.

The epoxy resin curable composition adheres well to a metal, glass, stone, concrete and the like, and can be used as an adhesive having an excellent color tone. The adhesive containing the epoxy resin curable composition is preferable as, for example, an adhesive for an iron plate, an adhesive for glass, an adhesive for a decorative item, an adhesive for a timepiece part, and an adhesive for DIY, and is particularly preferable as an adhesive for glass, an adhesive for a decorative item, an adhesive for a timepiece part, and an adhesive for DIY.

### EXAMPLES

Examples and Comparative Examples are described below. In the following Examples, a general reagent purchased from a reagent manufacturer was used as a raw material unless otherwise specified. The following apparatus and method were used for the analysis.

### Curing Time

The curing time of the epoxy resin curable composition was defined as a curing time when a toothpick was put into the epoxy resin curable composition and the toothpick stopped moving with reference to the method of determining a pot life of a multi-component adhesive described in JIS K 6870 (Method 1). Specifically, under conditions of 23° C. and 50% RH, the epoxy resin curable composition obtained by mixing the raw materials according to each example was pierced with a toothpick, and the point at which the toothpick did not move was measured as the curing time. The curing time was measured from the start of mixing, and was determined in units of minutes by checking the state of the toothpick every 30 seconds. In Examples 1 to 4 and Comparative Examples 1 to 12, a thiol compound A, a thiol compound B, and an amine compound were mixed at ratios shown in Tables 1 and 2 with 10 g of an epoxy resin.

### Hardness (Shore D Hardness)

The hardness of the epoxy resin curable composition was measured by the method specified in JIS K 7215. Specifically, the epoxy resin curable composition was poured into a plurality of containers having an inner diameter of 31 mm and a depth of 8 mm in a room at a temperature of 23° C. and a humidity of 50% RH, and after 3 hours and 24 hours from the start of mixing of the epoxy resin curable composition, samples for measurement having a diameter of 31×8 mm were obtained. The flat surface of the sample was measured using a type D durometer. The measurement was performed three times for each measurement sample, and an average value was taken as a hardness value.

### Lightness and Chromaticity

The lightness and chromaticity of the cured product of the epoxy resin were measured. Specifically, the epoxy resin curable composition according to each example was placed in a container having an inner diameter of 31 mm and a depth of 8 mm and curing was performed under conditions of 23° C. and 50% RH using a color difference meter (“CR-300” manufactured by Minolta Co., Ltd.) specified in JIS Z 8781-4. After 24 hours, the cured product of the epoxy resin was taken out from the container, and the lightness L*, the chromaticity a*, and the chromaticity b* of the cured product of the epoxy resin having a thickness of 8 mm were measured at room temperature. The measurement results of the chromaticities a* and b* were shown in Tables 1 and 2.

### Example 1

Under conditions of 23° C. and 50% RH, 7.9 g (79 parts by mass) of “Polythiol QE-340M” manufactured by Toray Fine Chemicals Co., Ltd. as a thiol compound A containing two or more thiol groups in one molecule, 1.0 g (10 parts by mass) of “TMMP” (trimethylolpropane tris(3-mercaptopropionate) manufactured by SC Organic Chemical Co., Ltd., in Formula (1), n was 1, R¹ was an ethylene group, R² was an ethyl group, and R³ was a methylene group, abbreviated as “TMMP” below and in the tables) as a thiol compound B, and 1.1 g (11 parts by mass) of “BB-AMINE 3138” manufactured by BB RESINS SRL as an amine compound containing a primary amino group and/or a secondary amino group were mixed with 10 g (100 parts by mass) of “jER828” (bisphenol A type epoxy resin, epoxy equivalent of 184 to 194 g/eq) manufactured by Mitsubishi Chemical Group Corporation as an epoxy resin containing two or more epoxy groups in one molecule with a spatula for 15 seconds, thereby obtaining an epoxy resin curable composition. The number of moles Me of the epoxy groups contained in the epoxy resin curable composition, the number of moles M_{A} of the thiol groups derived from the thiol compound A, and the number of moles M_{B} of the thiol groups derived from the thiol compound B were shown in Table 1. In addition, the molar ratios M_{A}/Me, M_{B}/Me, and M_{B}/M_{A} were calculated and described.

When the curing time at 23° C. was measured using the obtained epoxy resin curable composition, the epoxy resin curable composition was cured in 6 minutes. In addition, the Shore D hardness after 3 hours from the start of curing was 73, and the Shore D hardness after 24 hours from the start of curing was 78. Furthermore, when the chromaticity of the cured product of the epoxy resin curable composition was measured, the chromaticity a* was-3 and the chromaticity b* was 7. These results are shown in Table 1.

### Example 2

An epoxy resin curable composition was obtained in the same manner as that of Example 1, except that the thiol compound B was changed from TMMP to 1.0 g (10 parts by mass) of “PEMP” (pentaerythritol tetrakis(3-mercaptopropionate), in Formula (1), n was 0, R¹ was an ethylene group, and R³ was a methylene group, abbreviated as “PEMP” below and in the tables) manufactured by SC Organic Chemical Co., Ltd.

When the curing time at 23° C. was measured in the same manner as that of Example 1, the epoxy resin curable composition was cured in 6 minutes. In addition, the Shore D hardness after 3 hours from the start of curing was 77, and the Shore D hardness after 24 hours from the start of curing was 80. Furthermore, when the chromaticity of the cured product of the epoxy resin curable composition was measured, the chromaticity a was-3 and the chromaticity b* was 7. These results are shown in Table 1.

### Example 3

An epoxy resin curable composition was obtained in the same manner as that of Example 1, except that the amount of the thiol compound A was changed to 4.0 g (40 parts by mass) and the amount of the thiol compound B was changed to 0.3 g (3 parts by mass).

When the curing time at 23° C. was measured in the same manner as that of Example 1, the epoxy resin curable composition was cured in 6 minutes. In addition, the Shore D hardness after 3 hours from the start of curing was 76, and the Shore D hardness after 24 hours from the start of curing was 80. Furthermore, when the chromaticity of the cured product of the epoxy resin curable composition was measured, the chromaticity a* was-5 and the chromaticity b* was 7. These results are shown in Table 1.

### Example 4

An epoxy resin curable composition was obtained in the same manner as that of Example 1, except that the amount of the thiol compound A was changed to 4.0 g (40 parts by mass), the amount of the thiol compound B was changed to 0.3 g (3 parts by mass), and the amount of the amine compound was changed to 3.0 g (30 parts by mass).

When the curing time at 23° C. was measured in the same manner as that of Example 1, the epoxy resin curable composition was cured in 3 minutes. In addition, the Shore D hardness after 3 hours from the start of curing was 82, and the Shore D hardness after 24 hours from the start of curing was 81. Furthermore, when the chromaticity of the cured product of the epoxy resin curable composition was measured, the chromaticity a* was-5 and the chromaticity b* was 11. These results are shown in Table 1.

### Comparative Example 1

An epoxy resin curable composition was obtained in the same manner as that of Example 1, except that the amount of the thiol compound A was changed to 8.9 g (89 parts by mass) and the thiol compound B was not blended.

When the curing time at 23° C. was measured in the same manner as that of Example 1, the epoxy resin curable composition was cured in 6 minutes. In addition, the Shore D hardness after 3 hours from the start of curing was 72, and the Shore D hardness after 24 hours from the start of curing was 73. Furthermore, when the chromaticity of the cured product of the epoxy resin curable composition was measured, the chromaticity a* was-5 and the chromaticity b* was 7. These results are shown in Table 1.

### Comparative Example 2

An epoxy resin curable composition was obtained in the same manner as that of Example 1, except that the amount of the thiol compound A was changed to 0.1 g (1 part by mass) and the amount of the thiol compound B was changed to 8.8 g (88 parts by mass).

When the curing time at 23° C. was measured in the same manner as that of Example 1, the epoxy resin curable composition was cured in 11 minutes. In addition, the Shore D hardness after 3 hours from the start of curing was 37, and the Shore D hardness after 24 hours from the start of curing was 47. Furthermore, when the chromaticity of the cured product of the epoxy resin curable composition was measured, the chromaticity a* was 0 and the chromaticity b* was 10. These results are shown in Table 1.

### Comparative Example 3

An epoxy resin curable composition was obtained in the same manner as that of Example 1, except that the amount of the thiol compound A was changed to 11.9 g (119 parts by mass) and the amount of the thiol compound B was changed to 4.0 g (40 parts by mass).

When the curing time at 23° C. was measured in the same manner as that of Example 1, the epoxy resin curable composition was cured in 7 minutes. In addition, the Shore D hardness after 3 hours from the start of curing was 18, and the Shore D hardness after 24 hours from the start of curing was 18. Furthermore, when the chromaticity of the cured product of the epoxy resin curable composition was measured, the chromaticity a* was 0 and the chromaticity b* was 10. These results are shown in Table 1.

### Comparative Example 4

An epoxy resin curable composition was obtained in the same manner as that of Example 1, except that the amount of the thiol compound A was changed to 11.9 g (119 parts by mass) and the amount of the thiol compound B was changed to 0.3 g (3 parts by mass).

When the curing time at 23° C. was measured in the same manner as that of Example 1, the epoxy resin curable composition was cured in 7 minutes. In addition, the Shore D hardness after 3 hours from the start of curing was 42, and the Shore D hardness after 24 hours from the start of curing was 40. Furthermore, when the chromaticity of the cured product of the epoxy resin curable composition was measured, the chromaticity a was-2 and the chromaticity b* was 8. These results are shown in Table 1.

### Comparative Example 5

An epoxy resin curable composition was obtained in the same manner as that of Example 1, except that the amount of the thiol compound A was changed to 4.0 g (40 parts by mass) and the amount of the thiol compound B was changed to 4.0 g (40 parts by mass).

When the curing time at 23° C. was measured in the same manner as that of Example 1, the epoxy resin curable composition was cured in 6 minutes. In addition, the Shore D hardness after 3 hours from the start of curing was 76, and the Shore D hardness after 24 hours from the start of curing was 74. Furthermore, when the chromaticity of the cured product of the epoxy resin curable composition was measured, the chromaticity a was-1 and the chromaticity b* was 8. These results are shown in Table 2.

### Comparative Example 6

An epoxy resin curable composition was obtained in the same manner as that of Example 1, except that the amount of the thiol compound A was changed to 11.9 g (119 parts by mass), the amount of the thiol compound B was changed to 4.0 g (40 parts by mass), and the amount of the amine compound was changed to 3.0 g (30 parts by mass).

When the curing time at 23° C. was measured in the same manner as that of Example 1, the epoxy resin curable composition was cured in 4 minutes. In addition, the Shore D hardness after 3 hours from the start of curing was 7, and the Shore D hardness after 24 hours from the start of curing was 5. Furthermore, when the chromaticity of the cured product of the epoxy resin curable composition was measured, the chromaticity a was 2 and the chromaticity b* was 10. These results are shown in Table 2.

### Comparative Example 7

An epoxy resin curable composition was obtained in the same manner as that of Example 1, except that the amount of the thiol compound A was changed to 11.9 g (119 parts by mass), the amount of the thiol compound B was changed to 4.0 g (40 parts by mass), and the amount of the amine compound was changed to 0.5 g (5 parts by mass).

When the curing time at 23° C. was measured in the same manner as that of Example 1, the epoxy resin curable composition was cured in 24 minutes. In addition, the Shore D hardness after 3 hours from the start of curing was 19, and the Shore D hardness after 24 hours from the start of curing was 19. Furthermore, when the chromaticity of the cured product of the epoxy resin curable composition was measured, the chromaticity a* was-2 and the chromaticity b* was 8. These results are shown in Table 2.

### Comparative Example 8

An epoxy resin curable composition was obtained in the same manner as that of Example 1, except that the amount of the thiol compound A was changed to 11.9 g (119 parts by mass), the amount of the thiol compound B was changed to 0.3 g (3 parts by mass), and the amount of the amine compound was changed to 3.0 g (30 parts by mass).

When the curing time at 23° C. was measured in the same manner as that of Example 1, the epoxy resin curable composition was cured in 3 minutes. In addition, the Shore D hardness after 3 hours from the start of curing was 21, and the Shore D hardness after 24 hours from the start of curing was 18. Furthermore, when the chromaticity of the cured product of the epoxy resin curable composition was measured, the chromaticity a was 0 and the chromaticity b* was 10. These results are shown in Table 2.

### Comparative Example 9

An epoxy resin curable composition was obtained in the same manner as that of Example 1, except that the amount of the thiol compound A was changed to 11.9 g (119 parts by mass), the amount of the thiol compound B was changed to 0.3 g (3 parts by mass), and the amount of the amine compound was changed to 0.5 g (5 parts by mass).

When the curing time at 23° C. was measured in the same manner as that of Example 1, the epoxy resin curable composition was cured in 14 minutes. In addition, the Shore D hardness after 3 hours from the start of curing was 34, and the Shore D hardness after 24 hours from the start of curing was 51. Furthermore, when the chromaticity of the cured product of the epoxy resin curable composition was measured, the chromaticity a was-4 and the chromaticity b* was 6. These results are shown in Table 2.

### Comparative Example 10

An epoxy resin curable composition was obtained in the same manner as that of Example 1, except that the amount of the thiol compound A was changed to 4.0 g (40 parts by mass), the amount of the thiol compound B was changed to 4.0 g (40 parts by mass), and the amount of the amine compound was changed to 3.0 g (30 parts by mass).

When the curing time at 23° C. was measured in the same manner as that of Example 1, the epoxy resin curable composition was cured in 3 minutes. In addition, the Shore D hardness after 3 hours from the start of curing was 52, and the Shore D hardness after 24 hours from the start of curing was 50. Furthermore, when the chromaticity of the cured product of the epoxy resin curable composition was measured, the chromaticity a* was-5 and the chromaticity b* was 12. These results are shown in Table 2.

### Comparative Example 11

An epoxy resin curable composition was obtained in the same manner as that of Example 1, except that the amount of the thiol compound A was changed to 4.0 g (40 parts by mass), the amount of the thiol compound B was changed to 4.0 g (40 parts by mass), and the amount of the amine compound was changed to 0.5 g (5 parts by mass).

When the curing time at 23° C. was measured in the same manner as that of Example 1, the epoxy resin curable composition was cured in 30 minutes. In addition, the Shore D hardness after 3 hours from the start of curing was 51, and the Shore D hardness after 24 hours from the start of curing was 77. Furthermore, when the chromaticity of the cured product of the epoxy resin curable composition was measured, the chromaticity a* was-2 and the chromaticity b* was 8. These results are shown in Table 2.

TABLE 1

| | | | | | | Comparative | Comparative | Comparative | Comparative |
|---|---|---|---|---|---|---|---|---|---|
| | | Example 1 | Example 2 | Example 3 | Example 4 | Example 1 | Example 2 | Example 3 | Example 4 |
| Epoxy resin (parts by mass) | | 100 | 100 | 100 | 100 | 100 | 100 | 100 | 100 |
| Thiol compound A (parts by mass) | | 79 | 79 | 40 | 40 | 89 | 1 | 119 | 119 |
| Thiol | TMMP (parts by | 10 | 0 | 3 | 3 | 0 | 88 | 40 | 3 |
| compound B | mass) | | | | | | | | |
| | PEMP (parts by | 0 | 10 | 0 | 0 | 0 | 0 | 0 | 0 |
| | mass) | | | | | | | | |
| Amine compound (parts by mass) | | 11 | 11 | 11 | 30 | 11 | 11 | 11 | 11 |
| Number of moles Me of epoxy groups (mol) | | 0.59 | 0.59 | 0.59 | 0.59 | 0.59 | 0.59 | 0.59 | 0.59 |
| Number of moles M_{A}of thiol groups | | 0.34 | 0.34 | 0.17 | 0.17 | 0.38 | 0.01 | 0.50 | 0.50 |
| derived from thiol compound A (mol) | | | | | | | | | |
| Number of moles M_{B} of thiol groups | | 0.08 | 0.08 | 0.02 | 0.02 | 0.00 | 0.66 | 0.30 | 0.02 |
| derived from thiol compound B (mol) | | | | | | | | | |
| Molar ratio M_{A}/Me | | 0.57 | 0.57 | 0.29 | 0.29 | 0.64 | 0.02 | 0.86 | 0.86 |
| Molar ratio M_{B}/Me | | 0.13 | 0.14 | 0.04 | 0.04 | 0.00 | 1.12 | 0.51 | 0.04 |
| Molar ratio M_{B}/M_{A} | | 0.22 | 0.24 | 0.13 | 0.13 | 0.00 | 66.00 | 0.60 | 0.04 |
| Curing time (min) | | 6 | 6 | 6 | 3 | 6 | 11 | 7 | 7 |
| Hardness | 3 hours | 73 | 77 | 76 | 82 | 72 | 37 | 18 | 42 |
| Shore D | 24 hours | 78 | 80 | 80 | 81 | 73 | 47 | 18 | 40 |
| Chromaticity | a* | −3 | −3 | −5 | −5 | −5 | 0 | 0 | −2 |
| | b* | 7 | 7 | 7 | 11 | 7 | 10 | 10 | 8 |

TABLE 2

| | | Comparative | Comparative | Comparative | Comparative | Comparative | Comparative | Comparative |
|---|---|---|---|---|---|---|---|---|
| | | Example 5 | Example 6 | Example 7 | Example 8 | Example 9 | Example 10 | Example 11 |
| Epoxy resin (parts by mass) | | 100 | 100 | 100 | 100 | 100 | 100 | 100 |
| Thiol compound A (parts by mass) | | 40 | 119 | 119 | 119 | 119 | 40 | 40 |
| Thiol | TMMP (parts by | 40 | 40 | 40 | 3 | 3 | 40 | 40 |
| compound B | mass) | | | | | | | |
| | PEMP (parts by | 0 | 0 | 0 | 0 | 0 | 0 | 0 |
| | mass) | | | | | | | |
| Amine compound (parts by mass) | | 11 | 30 | 5 | 30 | 5 | 30 | 5 |
| Number of moles Me of epoxy groups (mol) | | 0.59 | 0.59 | 0.59 | 0.59 | 0.59 | 0.59 | 0.59 |
| Number of moles M_{A} of thiol groups | | 0.17 | 0.50 | 0.50 | 0.50 | 0.50 | 0.17 | 0.17 |
| derived from thiol compound A (mol) | | | | | | | | |
| Number of moles M_{B} of thiol groups | | 0.30 | 0.30 | 0.30 | 0.02 | 0.02 | 0.30 | 0.30 |
| derived from thiol compound B (mol) | | | | | | | | |
| Molar ratio M_{A}/Me | | 0.29 | 0.86 | 0.86 | 0.86 | 0.86 | 0.29 | 0.29 |
| Molar ratio M_{B}/Me | | 0.51 | 0.51 | 0.51 | 0.04 | 0.04 | 0.51 | 0.51 |
| Molar ratio M_{B}/M_{A} | | 1.77 | 0.60 | 0.60 | 0.04 | 0.04 | 1.77 | 1.77 |
| Curing time (min) | | 6 | 4 | 24 | 3 | 14 | 3 | 30 |
| Hardness | 3 hours | 76 | 7 | 19 | 21 | 34 | 52 | 51 |
| Shore D | 24 hours | 74 | 5 | 19 | 18 | 51 | 50 | 77 |
| Chromaticity | a* | −1 | 2 | −2 | 0 | −4 | −5 | −2 |
| | b* | 8 | 10 | 8 | 10 | 6 | 12 | 8 |

1.-8. (canceled)

9. An epoxy resin curable composition comprising an epoxy resin containing two or more epoxy groups in one molecule, a thiol compound A containing two or more thiol groups in one molecule, an amine compound containing a primary amino group and/or a secondary amino group, and a thiol compound B represented by any one of Formulas (1) to (3), wherein the thiol compound A and the thiol compound B are different from each other, and a molar ratio M_{A}/Me is 0.29 to 0.80 and a molar ratio M_{B}/Me is 0.02 to 0.4, in which Me is a number of moles of the epoxy groups contained in the epoxy resin curable composition, M_{A} is a number of moles of the thiol groups in the thiol compound A, and M_{B} is a number of moles of the thiol groups in the thiol compound B, 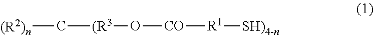
wherein, in Formula (1), R¹'s each independently represent an alkylene group having 1 to 10 carbon atoms, R² represents a hydrogen atom, an alkyl group having 1 to 10 carbon atoms, or a hydroxyalkyl group having 1 to 3 carbon atoms, R³'s each independently represent an alkylene group having 1 to 3 carbon atoms, n represents an integer of 0 to 2, and —SH is bonded to any carbon atom of R¹, 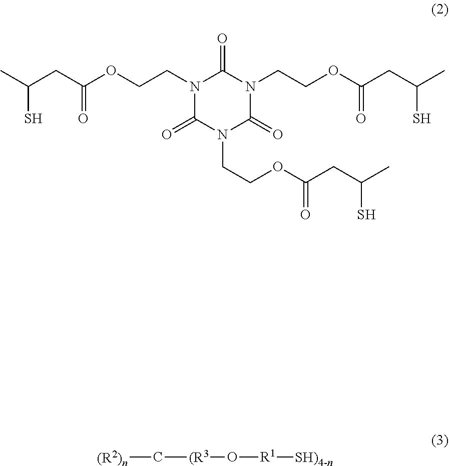
wherein, in Formula (3), R¹'s each independently represent an alkylene group having 1 to 10 carbon atoms, R² represents a hydrogen atom, an alkyl group having 1 to 10 carbon atoms, or a hydroxyalkyl group having 1 to 3 carbon atoms, R³'s each independently represent an alkylene group having 1 to 3 carbon atoms, n represents an integer of 0 to 2, and —SH is bonded to any carbon atom of R¹.

10. The epoxy resin curable composition according to claim 9, wherein a molar ratio M_{B}/M_{A} of the number of moles M_{B} of the thiol groups in the thiol compound B to the number of moles M_{A} of the thiol groups in the thiol compound A is 0.02 to 0.5.

11. The epoxy resin curable composition according to claim 9, wherein the thiol compound A does not contain a carbonyl group.

12. The epoxy resin curable composition according to claim 9, wherein a chromaticity a* and a chromaticity b* in an L*a*b* color system of a cured product are −10 to +10 and −15 to +15, respectively.

13. The epoxy resin curable composition according to claim 9, wherein a curing time when 10 g of the epoxy resin curable composition is used and cured at 23° C. and 50% RH is 1 to 15 minutes.

14. The epoxy resin curable composition according to claim 9, wherein when the epoxy resin curable composition is applied to a thickness of 6.0 mm or more and is cured at 23° C. and 50% RH, a Shore D hardness in accordance with JIS K7215 after 3 hours from a start of curing is 70 or more, and the Shore D hardness in accordance with JIS K7215 after 24 hours from the start of curing is 75 or more.

15. The epoxy resin curable composition according to claim 9, wherein the epoxy resin curable composition is used for an adhesive.

16. An adhesive comprising the epoxy resin curable composition according to claim 9.
